(19) United States
(12) Patent Application Publication
(10) Pub. No.: US 2020/0364690 A1
(43) Pub. Date: Nov. 19, 2020

(54) FINANCIAL AND SOCIO-EMOTIONAL MANAGEMENT SYSTEM AND PROCESS

(71) Applicant: Joseph Grant Brazier, III, Newbury Park, CA (US)

(72) Inventor: Joseph Grant Brazier, III, Newbury Park, CA (US)

(21) Appl. No.: 15/931,866

(22) Filed: May 14, 2020

Related U.S. Application Data
(60) Provisional application No. 62/849,600, filed on May 17, 2019.

(51) Int. Cl. G06Q 20/22; G06Q 20/40; G06Q 40/02; G06Q 10/10; G06Q 40/06; G06Q 20/10; G09B 19/18; G08B 21/02

(52) U.S. Cl. CPC G06Q 20/2295; G06Q 20/405; G06Q 40/02; G06Q 10/1095; G09B 5/065; G06Q 20/105; G09B 19/18; G08B 21/0205; G06Q 40/06

(57) ABSTRACT

A financial management control, training and use system and process allows a parent to create an account which is fully managed by the parent, but is for use by a child. A physical financial card, such as a smart card, debit or credit card, is created for a child of the parent. By means of a software application, a parent establishes parameters associated with the child's use of the account and financial card, including a budget for the child and spending restrictions for the account and/or financial card. The child may be required to go through interactive lessons, quizzes or educational games in order to unlock his or her account or make purchases. Activities associated with the account and financial card, including purchases, are tracked and a report is provided to the parent and child.

### RELATED APPLICATION

This application claims the benefit of U.S. Provisional Application No. 62/849,600, filed May 17, 2019.

### BACKGROUND OF THE INVENTION

The present invention generally relates to educational financial management systems. More specifically, the present invention is directed to a smart card financial and socio-emotional control, training, and use system embodied in a mobile application for a smartphone, tablet, mobile device, or stationary device having Internet connectivity.

Financial management is a necessary task which greatly affects the happiness and prosperity of households in the United States. When finances are wisely managed, a family will know their budget, be able to pay necessary expenses, build a savings, and know how much they can spend on entertainment, travel, etc. Thus, a family will gain greater happiness from managing their finances wisely because financial stresses stemming from not knowing where money is going, from feeling like money was wasted unnecessarily, and from not being able to pay for necessary expenses will be minimized.

Unfortunately, in today's society, many people do not understand or follow basic financial management principles. This largely has to do with the fact that many people have never had a financial management class because such classes have not traditionally been offered or required by the public education system. Furthermore, many people have not taken the time to learn financial management principles on their own. Consequently, in many families, parents do not feel comfortable or able to teach their children about financial management. Thus, children are more susceptible to form bad financial management habits that carry on into their adulthood.

It would therefore be advantageous to provide an educational financial management system that helps parents and children to learn and talk together about basic financial management principles. In today's world of technology and interaction, a financial management teaching system that uses current technology, such as being in the form of a mobile application, and allows for its users to learn through real world interaction would be well received.

There exist financial management teaching applications. While these applications are a great step for helping families to learn about financial management principles together, they do not contain features that would be highly beneficial in learning financial management principles and skills. For example, it would be beneficial to have a mobile application that helps a child see a budget and spend so they stay within that budget. It would also be advantageous to have a feature that allows parents to set limitations on where, when, and on what items money can be spent. It would also be helpful to have a feature that blocks a child's transaction if he or she spends outside of his or her budget or in some other restricted way. Also, a mobile application that has in-app lessons, videos, and educational games would help a child stay motivated to learn financial management principles.

Many people, particularly teenagers, struggle with anxiety, social and other emotional issues. Mental health is of an increasing concern. Many parents are either very busy with their professional lives and thus have limited time to interact with their teenagers to address such issues, or feel inadequate in helping them in these areas. The child may also not always want to communicate or convey their feelings, stress or anxiety to the parent. Emotional well-being affects other aspects of one's life. Accordingly, it would be helpful to have a system for assisting a person, such as a teenager, in assessing their social and emotional health on a regular basis, and provide tools and assistance in overcoming social and emotional difficulties and shortcomings. The present invention fulfills these financial and socio-emotional management and skill-building needs, and provides other related advantages.

### SUMMARY OF THE INVENTION

The present invention generally relates to a financial and socio-emotional well-being management system and process. The invention enables a parent to assist a child in learning financial management and socio-emotional skills with oversight from the parent and using tools and guidelines provided by the invention.

In accordance with the invention, an account is created which is fully managed by a parent. A physical financial debit or credit card is created for a child of the parent. This is typically created and issued by a bank or other financial institution, which may also provide a software application for use by the parent and child.

The parent establishes parameters associated with the child's use of the account and financial card. This may include a budget for the child as well as spending restrictions for the account and/or the financial card. A software application is downloaded at least to the memory of a child's computerized electronic device. A report is periodically provided to the parent and the child of tracked activities of the account. This may include purchases made with the account or financial card and the financial state of the account compared to the established budget and other parameters.

The child's computer may comprise a smartphone or other portable digital device. Typically, the parent downloads the software application to a computerized device of the parent for overseeing and managing the account. Managing the account may include establishing parameters, such as setting limitations as to where, when or on what items may be purchased by the child using the account or the financial card. The budget may be established by the parent for the child in a plurality of pre-selected purchase categories.

The account or a prepaid financial card is funded, typically by the parent. The frequency of funding the account or financial card may be established. The child may also be able to fund the account or financial card from his or her own income.

A perks marketplace may be created. The parent may establish a savings goal for the child to purchase items from the perks marketplace. The parent and/or child may establish a savings goal over a predetermined period of time for the child. The savings of the child may be tracked and reported over the period of time. Achievement of a savings goal may result in a benefit, such as the ability to purchase items from the perks marketplace. The child may also be able to not only save, but invest excess money not spent after a budget time period.

A financial score of the child's account may be determined, such as being based upon past purchases, savings and attainment of preset goals. The financial score may be periodically updated and displayed to the parent and/or child. Such a financial score may be similar to a credit score, which may assist the child in understanding the importance of achieving a high credit score.

A financial literacy curriculum may be provided for the child. This may comprise videos, games, quizzes and/or interactive lessons. The child may review items from the literacy curriculum to improve the child's financial literacy. The child may be required to complete a component or item of the financial literacy curriculum in response to a financial action or decision taken by the child, or as a requirement to continue to purchase items using the account or financial card. The parent may have the ability to selectively lock and unlock the ability of the child to make purchases using the account or financial card.

The invention contemplates permitting digital payments between the child and a third party. The parent may establish digital payment limitations in the account as well.

The parent or child may enter events for a schedule of the child. The system and process of the present invention provides reminders to the parent and/or child of the events during a time period of the schedule. The parent and/or child may set an alarm for an event. The alarm will be automatically activated at the preset time. This may be, for example, a time to wake up in the morning, or accomplish a task, leave for a practice or an event or the like.

The system may periodically inquiry and/or the child periodically input socio-emotional health of the child. A video, article or the like from a playlist may be displayed or provided in response to the socio-emotional health input by the child. Additionally, or alternatively, a skill advancement or socio-emotional assistant playlist of videos, articles and the like may be provided for viewing and completion by the child.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view of components of a system used in accordance with and embodying the system of the present invention;

FIG. 2 is a flowchart illustrating the steps taken in conjunction with setting up an account, in accordance with the present invention;

FIG. 3 is a flowchart illustrating the steps of associating a financial card with the account, and creating account limitations and parameters;

FIG. 4 is a flowchart illustrating the steps taken in conjunction with funding the financial card and/or account;

FIG. 5 is a flowchart illustrating the steps a child must take to download and to start using the system as well as the features the child will see while using the system;

FIG. 6 is a flowchart illustrating the processing operations associated with the educational features of the system;

FIG. 7 is a flowchart illustrating the processing operations associated with the data collection features of the system;

FIG. 8 is a flowchart illustrating the options a child has to save and invest money using the system;

FIG. 9 is a flowchart illustrating the features of the system allowing a user to send and receive money;

FIG. 10 is a flowchart illustrating the processing operations associated with a transaction made using the system and parental controls of the system; and

FIG. 11 is a flowchart illustrating the steps taken in connection with the system and process of the present invention relating to socio-emotional health tracking and management.

### DETAILED DESCRIPTION OF THE PREFERRED EMBODIMENTS

As shown in the accompanying drawings, for purposes of illustration, the present invention is directed to a financial and socio-emotional management system and process. The system and process of the present invention allows parents to create a family account which children may join, wherein each child has a prepaid debit or credit card or other financial card associated with the system and may be used for purchases. The parent may set limiting filters for items, location, time and amount of money the child can spend. The system also keeps track of the child's balance and allows parents to provide the child with an allowance. When a child tries to make a purchase not passing the set filters, the child's card and account will be placed on hold and the child may be required to go through interactive lessons, quizzes, and/or educational games in order to unlock his or her account. The system and process of the present invention can also be used to assess and assist the child in his or her social and emotional well-being.

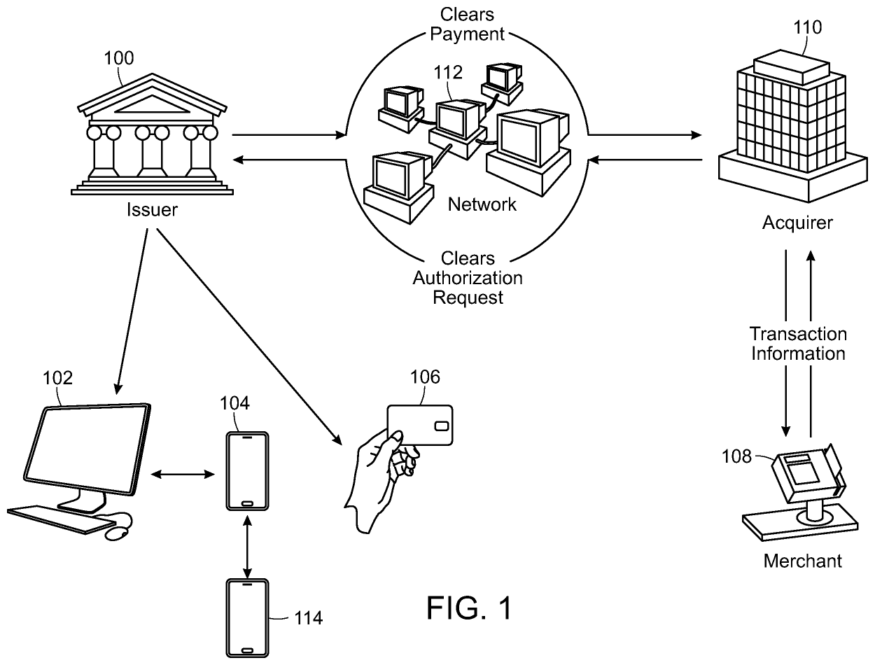

With reference now to FIG. 1, a diagrammatic view is shown illustrating various components of the financial management system of the present invention. An issuer 100, such as a bank or other financial institution, may provide a software application embodying an aspect of the invention. It will be understood, however, that the software application may be obtained by other means. A parent downloads the software application onto his or her computerized device 102. The smart card financial control, training and use system of the present invention may be embodied in a mobile application or in some other form. Generally, the system is meant to benefit three groups: banks/credit unions or other financial institutions, parents/guardians, and adolescents. As mentioned above, the software of the system may be a third-party plug-in that any bank, credit union, or mega-retailer may easily integrate into their current mobile technology. These services may then distribute the system to their customers and use the system as a part of any financial education programs that they may offer. Parents may download the system from the issuer, such as a bank or credit union, as a tool to teach the children essential financial management principles.

As will be more fully described herein, the parent may establish an account, such as a family account, which is fully managed by the parent. Parents may create budgets, set limitations, and set financial goals for their children to follow. As part of the system, parents will be able to view the spending habits of their children and learn how to teach financial principles to their children through the software or a website associated with the system.

A child of the parent downloads the system, such as in the form of a software application, to his or her computerized electronic device 104, such as a smartphone or other portable digital device. The child may then either join the family account or the account established and fully managed by the parent. The financial institution 100, or other issuer, issues a physical financial card 106, such as in the form of a debit card, credit card, or a prepaid card 106 or the like. The child may use the financial card 106 and account to make purchases, based upon the parameters and limitations which the parent has established with respect to use of the account and financial card.

The child may use the financial card 106 or account to make purchases, such as through a merchant 108. Such purchases will involve transaction information relating to the financial card 106 and/or account, which is shared with an acquirer 110, which information passes through a network 112, to the financial institution or issuer 100 so that the authorization request may be cleared and the payment may be made from the issuer 100 to the acquirer 110 and to the merchant 108 for the goods or services purchased by the child using the financial card 106 and/or account. The invention also contemplates the ability to make digital purchases or financial transactions between the child's account, such as through his or her smartphone 104, to another digital account 114 of a third party. The child will benefit from the system of the present invention as they will learn essential financial management skills, which may be augmented through videos, lessons, games and real-world interaction as provided for by the system.

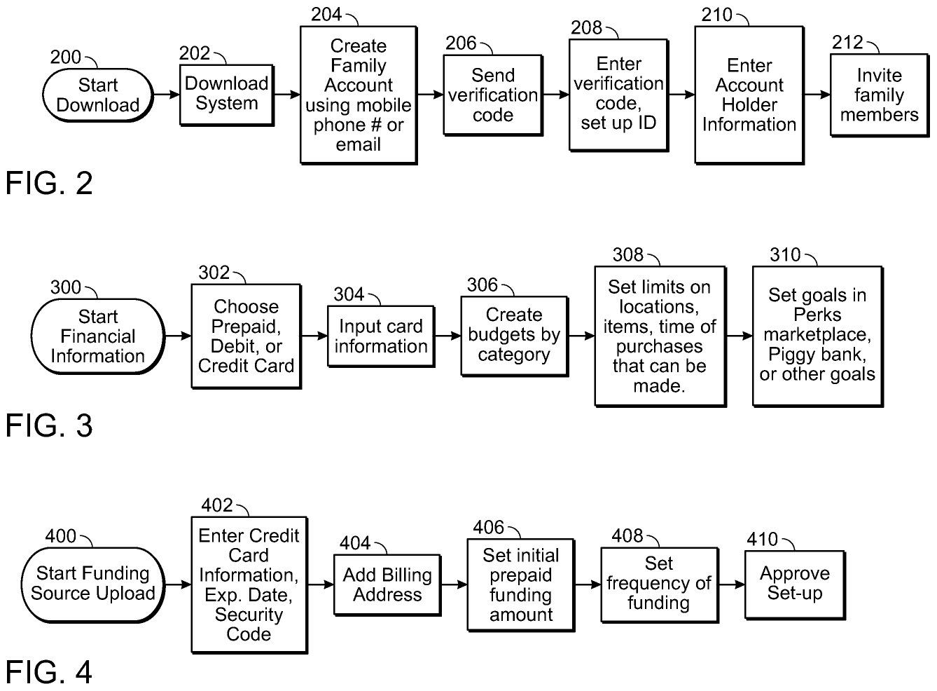

With reference now to FIG. 2, to start using the system, the software application system must be downloaded 200. Thus, the system is downloaded 202 by the parent, typically to a computerized device of the parent. As mentioned above, the system, particularly in the form of a software application, may be provided through a participating bank or credit union or other financial institution. An account is then created by the parent. The parent may create a family account, such as using a mobile phone number and/or email or other information 204. A verification code is then sent 206 to the parent, such as to his or her mobile phone number, email or the like. A verification code 208 may be entered by the parent, and once this is done the parent, the accountholder, will enter his or her identification information, such as name, email address, mobile phone number, and potentially other information 210. Once the parent has downloaded the system and after an account has been created, the parent may invite family members 212, such as his or her children, to join the family account, or the account set up for that child. This may be done, for example, through an email message, text message, SMS message or the like.

With reference now to FIG. 3, after the system is downloaded and an account is created by the parent, financial information is entered 300. This process is completed for each child that will use the family account, or for each of the children's accounts. The parent chooses a financial card, such as a prepaid card, debit card or credit card 302 from his or her financial institution or other issuer that will be used by the child. A physical financial card is created and sent to the parent and/or child for the child's use. Preferably this card will be from the child's own account with a financial institution, but may be from the parent's account where the child is an authorized user. Once this card is selected for the child, the card information is input 304 into the system.

The parent then establishes parameters associated with the child's use of the account and financial card. This may include creating or establishing a budget for the child 306. One or more budgets may be created by category. These categories may include any category commonly found on a budget, such as food and drink, entertainment, shopping, etc. The child will be required to stay within the budget for these one or more categories. The parent is also allowed to set limits or establish spending restrictions for the account and/or the financial card of the child 308. Such limits can include the locations, items, and time of purchases that can be made. For example, the parent may block a child from spending money at certain stores or outside of a certain geographic location. The parent may block a child from making purchases on specific items or categories, such as gambling, gaming, pornography, etc. The parent may also limit when a child is able to spend money, such as not allowing the child to spend money during school hours or late in the evening. Thus, the parent may establish parameters setting limitations as to where, when or on what items may be purchased by the child using the account or the financial card.

Preferably, in addition to one or more budgets, the parent and/or child may set goals for the account. These goals may be set in three distinct sections of the system known as Perks Marketplace, Piggybank, or other goals 310 for the child to work towards. The system may allow the parent to establish goals for the child as well as the child may be able to establish his or her own goals. The goals set by the parent for the child to work towards may be marked as parental goals so as to distinguish them from the child's own goals. These goals may be tracked over time and report generated by the system to the parent and/or child.

In the Perks Marketplace, a parent may set goals for a child to save towards specific items. The Perks Marketplace may be a feature of the system that lists items from participating vendors, which may be at discounted prices, that the child may select from and save towards. Once the child has saved enough, the system will alert the child and the child may then proceed to purchase the item from the Perks Marketplace.

In the Piggybank feature, a parent may set goals for the child to establish a savings. Alternatively, or additionally, the parent may set a goal for the child to establish as savings of a specific dollar amount within a certain time frame. The Piggybank feature of the present invention tracks the savings and allows the parent and/or child to easily see how the child is progressing in his or her savings over time.

The system of the present invention may also enable the parent and/or child to establish other goals that are not part of the Perks Marketplace or the Piggybank sections. A set list of goals could be provided by the system to the parent and/or child to choose from, such as investing a certain amount of money, donating a certain amount of money, etc. Alternatively, the parent and/or child can establish their own goals within the system. Thus, the parent and/or child may create a custom goal to work towards that is not otherwise listed in the system.

With reference now to FIG. 4, the account and/or financial card is typically funded, and thus this begins with starting the funding of the source upload 400. The financial card information, such as the expiration date, security code, etc. is entered into the system 402 such that the financial card is linked or associated with the account. Other information, such as billing address 404 is entered as needed to activate the financial card and/or link or otherwise associate it to the family or child's account. The financial card may be dedicated and exclusive to the child, or may be the parent's financial card of which the child is an authorized user.

With continuing reference to FIG. 4, an initial prepaid funding amount is set 406. The parent has an opportunity to set an initial prepaid funding amount for each child associated with the parent's or family account, or each of the children's accounts. For example, the parent may provide each child with fifty dollars to start their account with the system. This may be in the form of applying a dollar amount to a prepaid financial card, or depositing that amount into the account. Next, the parent may set a frequency of funding 408 for the account, or each child on the account. This could be similar to an allowance. The parent can choose how often the child receives money, such as weekly, monthly, etc. The parent may also choose how much money the child will receive on those periods. The parent will then be asked to approve the funding setup 410. Once the parent approves the setup, the parent will have completed the steps necessary on his or her part in order to start use of the system by the child.

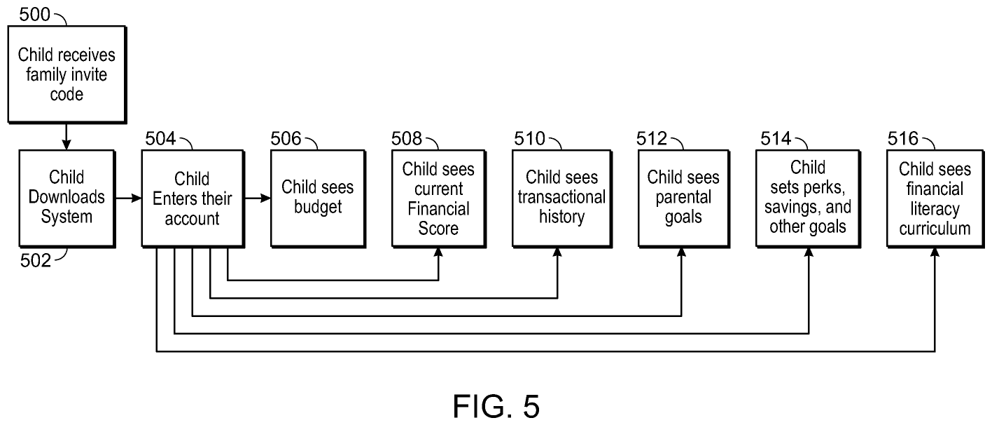

With reference now to FIG. 5, after the account which is to be managed by the parent has been created and established, the child receives an invite code 500. The child downloads the system 502 to his or her computerized electronic device, such as a smartphone or the like. After the download, a child may start using the system by entering his or her account 504 using the invite code. The child is able to see the various parameters established by his or her parent in the account. For example, the child may be able to see the budget 506 and the one or more categories selected and established by the parent. In accordance with the present invention, a financial score is created for the child and his or her account, which the child may be able to see or which is periodically displayed to the child 508. The financial score is established by how the child interacts with the economy, making it similar to a real-world credit score. The financial score will improve as the child stays within the established budgets and limitations set by the parent. The financial score will also improve when the child reaches goals set by the parent and/or child. On the other hand, this financial score will decrease when the child fails to stay within the set budget or other parameters, such as the child trying to make purchases against the set limitations. The financial score may also decrease when the child fails to meet set goals. The child will be able to view the transactional history of the financial card and/or account 510. The child will also be able to view, or is periodically presented with, the established goals, such as the parental goals 512. The child may also be able to set his or her own goals, such as the Perks Marketplace goals, Piggybank account goals, savings goals or the like 514.

In accordance with the present invention, a financial literacy curriculum is provided to the child and/or parent. The child is able to view the aspects of the financial literacy curriculum 516, which may comprise interactive lessons, videos, games, questions, review questions, etc. to help the child learn about financial management. These features may be in the software application downloaded by the child and/or may also be part of a website associated with the system. It is contemplated by the present invention that the financial literacy curriculum may provide mandatory lessons that the child must complete before continuing to use the system. For example, certain aspects of the literacy curriculum must be completed in order to begin making purchases, or to make certain types of purchases. In other situations, types of lessons may be required when the child tries to make a purchase outside of the set budget or limitations. A skill financial literacy curriculum in the form of a playlist may be accessed by the child for learning at any other time. For example, it may be accessed at times when required by the parent to teach the child or at times for the enjoyment and the curiosity of the child.

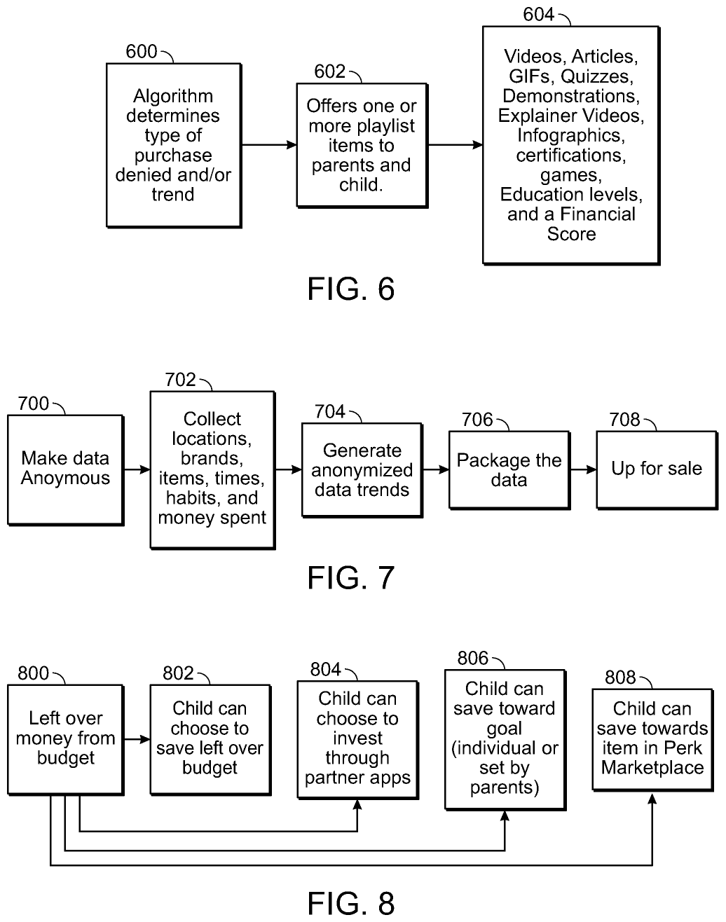

With reference now to FIG. 6, the algorithm of the present invention determines the type of purchase the child is attempting to make and which has either been denied and/or purchasing trends of the child 600. In response to this, the system may offer one or more playlist items of the financial curriculum to the parent and/or child 602. As described above, the financial curriculum may comprise videos, articles, GIFs, quizzes, demonstrations, explainer videos, infographics, certifications, games, education levels, etc. as well as a financial score 604. This educational feature of the system of the present invention offers a financial literacy curriculum through in-app teaching and/or a website. When a child makes a mistake by going outside of the set budget or by being denied a purchase due to the limitations set by the parent, the system gives an appropriate lesson from the curriculum that the child must complete before the child can continue using the system, such as making purchases through the financial card or account. Furthermore, the system may notify the parent and suggest lessons, articles or the like directed toward helping the parent to teach the child to learn from the mistake and how to better manage finances. As mentioned above, an algorithm of the software application of the present invention may be able to understand or determine the purchasing trends of the child, when the child makes a mistake, such as when a purchase is denied due to preset limitations, or the like. After a mistake is made, the system will offer to the parent and/or child an educational activity tailored for the education of the child based on the child's purchasing trends, denied purchases, failure to adhere to the established budgets, or the like.

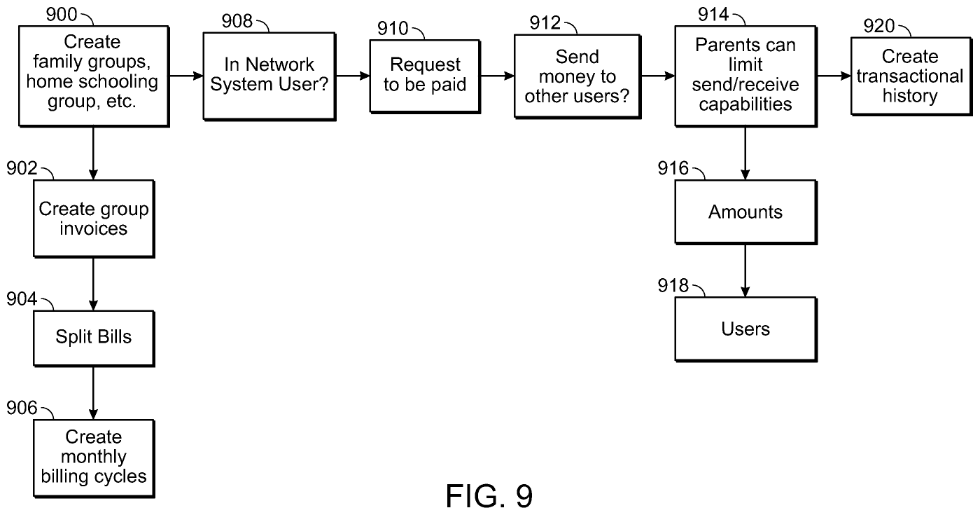

With reference to FIG. 9, a flowchart is provided illustrating how money is sent and received using the system of the present invention. Aside from using the credit card, debit card, prepaid card or other financial card, assigned to him or her, a child may send and receive money directly through the system. Groups may be created 900, such as family groups, home schooling groups, or other groups for which fees may be shared or split. In these groups, users may create group invoices 902, split bills 904, and/or create monthly billing cycles 906.

With continued reference to FIG. 9, the money sender and the money receiver must typically both hold accounts associated with the system, or in other words be a network system user 908. When both parties are users of the system, a receiving user may request to be paid 910 by a sending user that owes money. When a request is made, the sending user will receive a notification that the receiving user has requested to be paid a certain amount of money, with a query whether to send money to the other use 912. The sending user will then have the option to send the money requested or to reject the request. When a sending user accepts the request and sends the money, the receiving user is notified by the system and a record of the transaction is stored within the system. However, if the sending user chooses to reject the request, the sending receiver will be given the option to provide an explanation of why he or she rejected the request. A notification with the explanation, if provided, will then be sent to the receiving user. Both parties may then pursue other options to resolve the payment. If the sending user does not choose to accept or reject the request within a given period of time, the sending user will again be notified of the request. If the user still fails to choose one of these options, then the sending user and the receiving user may again pursue other options to resolve the payment.

Besides requesting money from another user associated with the system, a user may also send money to another user even if no request has been made. When a user sends money, the receiving user will be notified by the system of the sent money and may again have the option to accept or reject the sent money. If the money is accepted, the money will be sent and a record will be kept in the system. The sender may also have the option to send an explanation along with the money. For example, the sender may use the explanation feature to notify the receiver that the money is for a gift, to pay for a rendered service, or other explanation. This explanation will be recorded in the transactional history kept by the system so as to allow the parent and child to know exactly what the money was sent or received for. All of the sending and receiving transactions will be recorded in the system and saved as part of a transactional history.

Parents, as managers of the account, can limit the send/receive capabilities 914 of the child and his or her financial card and/or account. This includes the amounts which may be sent or received 916, and the third-party users 918 which can send or receive money to or from the child's account. As mentioned above, a transactional history is created 920 for all such financial transactions and any limitations. Thus the parent, as well as the child, can view what financial transactions have been made in accordance with this aspect of the invention.

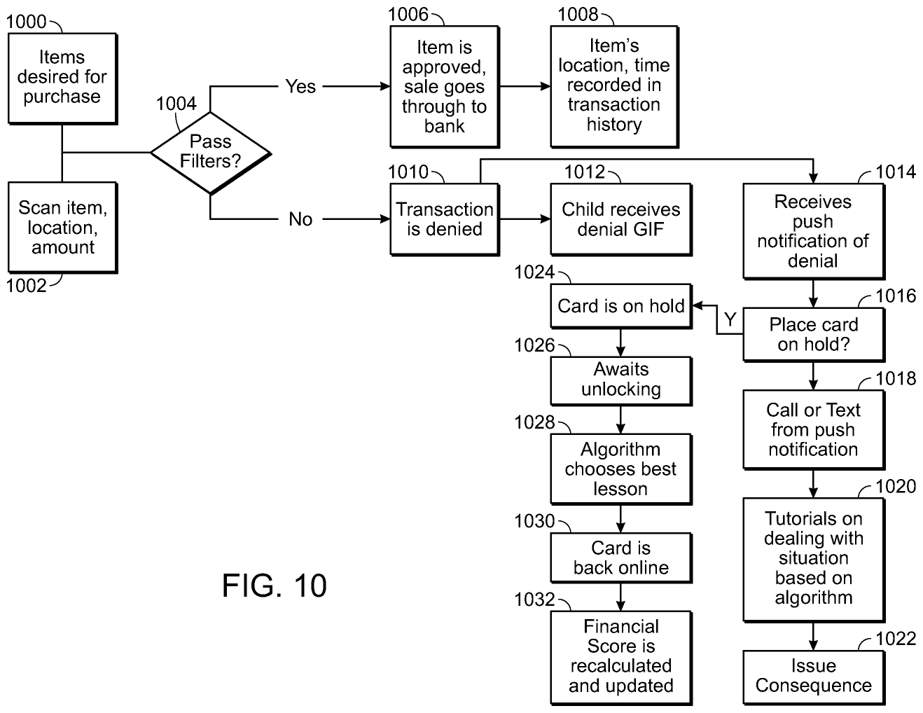

With reference now to FIG. 10, steps associated with the processing operations that take place when a purchase is made using the account or financial card with the system is shown. The child selects one or more items desired to be purchased 1000. The system compares the items and transaction to the set filters established by the parents for items, location, cost, time or other filters established by the parent, as previously described 1002. The system of the present invention requires the transaction not be blocked by any of the filters in order for the transaction to be completed. If the transaction does pass the set filters 1004, then it is approved and the sale goes through to the bank or other financial institution 1006. The items, location, time and other information are recorded in the transaction history 1008 of the system, which may be reviewed by the parent or child at any time.

However, if the transaction does not pass the set filters 1004, then the transaction is denied 1010. The child receives notification of the denial 1012. Also, a push notification is received by the parent of the denial 1014. These notifications can be in a variety of forms, such as a graphic interchange format (GIF) notification, text message, email message, or any other appropriate electronic message.

After the denial, the parent may be given the option to place the account and financial card on hold 1016. The system may be set up such that after a denial, the child's card and account are automatically placed on hold to block all future transactions, and the parent will have the ability to keep the card and account on hold, or to forgive the denial. In making this decision, the parent may have the ability to call or to text the child directly from the push notification 1018 in order to determine the child's situation. The system may present the parent tutorials on dealing with the situation based upon an algorithm within the software 1020. The parent may also determine an issue consequence 1022, such as issuing consequences on the child's account, such as adjusting the budget, placing more filters, lowering the allowance received, etc.

When the child's account and financial card is placed on hold 1024, either automatically by the system and/or by the parent, the child must wait for the account and card to be unlocked 1026. As mentioned above, the parent may elect to unlock the account and card. Alternatively, or additionally, the system may provide a lesson from the educational curriculum 1028 that the child must review and complete before the account is unlocked. The algorithm may determine the one or more items from the financial education curriculum based upon the child's purchasing trends, type of denial, etc. Once this is completed, or the parent unlocks the card, the card and account is back online 1030. The financial score is recalculated and updated 1032 to reflect the denied transaction.

With reference now to FIG. 8, a flowchart depicts steps of options that the system may allow the child to choose from when the child has leftover money from his or her budget. Thus, when there is leftover money from the budget 800, the child can choose to save the leftover money from the budget 802. This may be, for example, through the Piggybank feature of the system, as discussed above. This allows the child to easily see where the money is saved as well as the amount of money in his or her savings through the system of the present invention. Another option is to provide the child an opportunity to invest through partner applications 804. This option allows the child to see the amount of money invested, what the money is invested in, as well as the earnings or losses from the investments. Yet another option to provide the child is to have the money saved towards a goal, either an individual goal by the child and/or set by the parents 806. Here, the child may see the amount of money set aside to reach the goal as well as to calculate how much money should be saved over a given period of time to reach the set goal by a specific date. Alternatively, the child may save towards an item in the Perks Marketplace 808, for purchasing items through the Perks Marketplace, as discussed above.

With reference now to FIG. 7, the present invention contemplates a feature of the system being a data collection feature, which allows the system to collect and anonymize data on spending habits in the youth market and compile this data into useful marketing information which may be sold. First, the data must be made anonymous 700. When the system is gathering data on the spending habits of its users, the system will delete all associated identifying information so as to make the data completely anonymous. The system may collect information on the locations of purchases, brands of the items, times of the purchases, spending habits and money spent 702. From this data, the system will generate anonymized data trends 704. These data trends will then be packaged 706 and may be offered up for sale 708 for the benefit of companies, market analysis, researchers, financial advisors, etc.

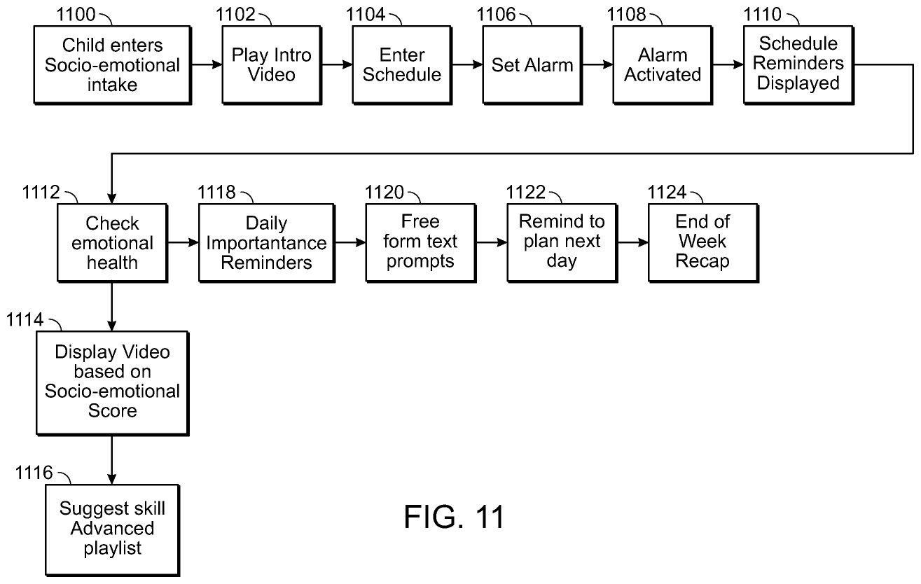

With reference now to FIG. 11, it has been determined that parents and youth are not only looking for platforms and tools to help them with financial literacy, but also life literacy, including adult daily living skills, executive functioning skills, social skills and emotional skills and health. Thus, an aspect of the system of the present invention teaches children about the real world while they are living in the real world on a day-to-day basis. Thus, the system tracks not only the child's financial transactions and financial score, but also a socio-emotional score, reflecting how the child is feeling about things going on in their lives. The system may make suggestions based upon how the child is doing in certain skills and provides reminders by the system, so as to check in with the child. It has been found that children actually want to be checked in with in many of these aspects. Thus, the system of the present invention combines financial management and literacy with socio-emotional management and literacy.

With reference to FIG. 11, the child enters the socio-emotional intake portion of the system 1100. An introduction video may be played 1102 which may be related to the socio-emotional skill platform. The child or parent may enter a schedule 1104, which may be a daily, weekly, monthly, etc. schedule. Alarms may be set 1106 by the parent and/or child. At the appropriate time, an alarm is activated 1108, so as to awaken the child in the morning, notify the child of an event that the child needs to attend to in a timely manner, such as doing homework, leaving for a sports or music practice, or the like. Reminders are displayed of the schedule 1110 that the child or parent has established.

The system performs periodic emotional health checks 1112. These may be provided on a daily basis, or even multiple times a day. The emotional health check may be alterable in frequency by the parent or child. This may be in the form of a thumbs up, thumbs down, one-ten scale, happy face to sad face scale or the like. A video may be displayed based on the socio-emotional score 1014 that the child entered. The system may also suggest one or more advance skills from a playlist 1116. Such videos, articles, etc. from a socio-emotional educational curriculum can assist the child in dealing with various social, emotional and like literacy aspects.

The system may display important reminders, such as on a daily basis 1118. These reminders and check-ins may be based on what is important to the child that day. The system may ask during the day in free-form text prompts 1120 certain important subjects. The system may also reminder the child to plan or schedule the upcoming time period, such as the next day 1122. The system may provide an end-of-the-week recap 1124, to the child and/or the parent.

Thus, the socio-emotional skill-training platform and use of the system allows users, both parent and child, to track their financial and socio-emotional well-being while learning/practicing sound financial literacy and adult daily living skills with real-world curriculum application through an associated prepaid, debit or credit card. Parent users may set limiting filters for interaction with a financial ecosystem. Young users are taught skill-training through in-depth intake process of their personality, socio/emotional/financial needs. Young users plan their days and check-ins on platforms which in turn uses data to suggest learning and practice of adult daily living skills and sound financial literacy for successful launch into adulthood.

Although several embodiments have been described in detail for purposes of illustration, various modifications may be made without departing from the scope and spirit of the invention. Accordingly, the invention is not to be limited, except as by the appended claims.

What is claimed is:

1. A financial management system and process, comprising:
creating an account fully managed by a parent;
creating a physical financial debit or credit card for a child of the parent;
downloading a software application to memory of a child's computerized electronic device;
the parent establishing parameters associated with the child's use of the account and financial card, including a budget for the child and spending restrictions for the account and/or the financial card; and
providing a report to the parent and the child of tracked activities of the account, including purchases made with the account or financial card and a financial state of the account compared to the established budget.

2. The process of claim 1, wherein the child's computer comprises a smartphone or portable digital device.

3. The process of claim 1, wherein the establishing parameters step includes the step of the parent setting limitations as to where, when, or on what items may be purchased by the child using the account or the financial card.

4. The process of claim 1, wherein the budget is established by the parent for the child in a plurality of preselected purchase categories.

5. The process of claim 1, including the step of the parent funding the account or a prepaid financial card.

6. The process of claim 5, including the step of establishing a frequency of funding of the account or financial card.

7. The process of claim 1, including the step of creating a perks marketplace wherein the parent establishes a savings goal for the child to purchase items from the perks marketplace.

8. The process of claim 1, including the steps of establishing a savings goal over a predetermined period of time for the child and tracking and reporting the savings of the child over the period of time.

9. The process of claim 1, including the steps of determining a financial score of the child's account based on past purchases, savings and attainment of preset goals, and displaying the financial score to the parent and child.

10. The process of claim 1, including the step of providing a financial literacy curriculum for the child, comprising videos, games, quizzes and interactive lessons.

11. The process of claim 10, including the step of requiring that the child complete a component of the financial literacy curriculum in response to a financial action taken by the child or as a requirement to continue to purchase items.

12. The process of claim 1, including the step of enabling the child to save or invest excess money not spent after a budget time period.

13. The process of claim 1, including the step of permitting digital payments between the child and a third party, and the parent establishing digital payment limitations in the account.

14. The process of claim 1, including the step of the parent selectively locking and unlocking the ability of the child to make purchases using the account or financial card.

15. The process of claim 1, including the step of the parent and/or child entering events for a schedule of the child, and providing reminders to the parent and child of the events during a time period of the schedule.

16. The process of claim 1, including the step of the parent and/or child setting an alarm for an event, and activating the alarm at the set time.

17. The process of claim 1, including the step of the child periodically inputting socio-emotional health of the child.

18. The process of claim 17, including the step of displaying a video or article from a playlist in response to the socio-emotional health input by the child.

19. The process of claim 1, including the step of providing a skill advancement or socio-emotional assistance playlist of videos or articles for viewing by the child.
